(19) United States
(12) Patent Application Publication
(10) Pub. No.: US 2024/0383620 A1
(43) Pub. Date: Nov. 21, 2024

(54) DETERMINATION OF POSITIONING OF SATELLITES ASSOCIATED WITH EDGE-COMPUTING

(71) Applicant: International Business Machines Corporation, Armonk, NY (US)

(72) Inventors: Sudheesh S. Kairali, Kozhikode (IN); Sarbajit K. Rakshit, Kolkata (IN)

(21) Appl. No.: 18/320,429

(22) Filed: May 19, 2023

(51) Int. Cl. B64G 1/24; G06F 9/50

(52) U.S. Cl. CPC B64G 1/242; G06F 9/5027; B64G 1/002; B64G 1/245

(57) ABSTRACT

An approach for managing location of satellites associated with edge computing is disclosed. The approach includes, identifying a group of satellites using edge computing; determining a computation requirement associated with the edge computing; determining existing computational resources associated the group of satellites; determining whether the computation requirement exceeds the existing computation resources; in responsive to having determined that the computational requirement does exceed the existing computation resources, identifying addition resources required; determining one or more orbital positions for the additional resources; and placing the additional resources into the one or more orbital positions in order to participate in the edge computing.

### BACKGROUND

The present invention relates generally to space mission planning and more particularly launching of satellites and other payloads into space.

When the satellites are launched, then the satellites are communicating with each other and participating in edge-computing, in this case, the satellites are also sending information to ISS to perform various research in micro-gravity environment.

Currently, many private companies are launching satellites very frequently. Deployment of Low Orbit Earth (LEO) satellite-based secure storage will protect critical data from unauthorized access while supporting global communications at reduced latency of today's multi-hop networks.

The European Space Agency (ESA) and an SES-led consortium are developing a system that will allow the generation of encryption keys from space, as well as their secure transmission to users on Earth via laser. NASA intends to shift its space-to-ground data communications from traditional radio to laser. The move may help internet throughput via over-the-air laser optical become a reality. Lasers will allow real-time satellite communications.

### SUMMARY

Aspects of the present invention disclose a computer-implemented method, a computer system and computer program product for managing location of satellites associated with edge computing. The computer implemented method may be implemented by one or more computer processors and may include: identifying a group of satellites using edge computing; determining a computation requirement associated with the edge computing; determining existing computational resources associated the group of satellites; determining whether the computation requirement exceeds the existing computation resources; in responsive to having determined that the computational requirement does exceed the existing computation resources, identifying addition resources required; determining one or more orbital positions for the additional resources; and placing the additional resources into the one or more orbital positions in order to participate in the edge computing.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a diagram illustrating a high level overview of the functionality of the system, designated as environment 100, in accordance with an embodiment of the present invention;

FIG. 2 is a diagram illustrating satellite positioning and possible gaps in edge computing infrastructure, designated as 200, in accordance with an embodiment of the present invention;

FIG. 3A is a diagram illustrating orbital zones in a 3D space relative to the earth as it relates to edge computing infrastructure, designated as 300A, in accordance with an embodiment of the present invention;

FIG. 3B is a diagram illustrating a different perspective/view relating to orbital zones from FIG. 3A, in accordance with an embodiment of the present invention;

FIG. 4 is a high-level flowchart illustrating the operation of satellite management component 111, designated as 400, in accordance with an embodiment of the present invention; and

FIG. 5 depicts a block diagram, designated as 500, of components of a server computer capable of executing the satellite management component 111 within environment 100, in accordance with an embodiment of the present invention.

### DETAILED DESCRIPTION

Generally, to establish edge-computing ecosystem, there is a requirement to ensure that the number of edge devices including processing, storage capability have the minimum distance among the edge devices in order to communicate with each other and perform the edge-computing. Similarly, satellites are typically equipped with computing system that communicate with other land and/or space electronic devices. Thus, when the satellites are launched, the satellites are communicating with each other and participating in an edge-computing infrastructure/ecosystem. However, if the satellites are not deployed in the proper orbits, then it will not be able to perform proper edge-computing.

Thus, there is a need to ensure that satellites are launched into proper orbit in order to communicate with each other as part of an edge-computing ecosystem. Current methods of calculating path for launching satellite vehicles rely on a “collision model”, wherein the secondary space vehicle should be no closer than certain distance to the proposed user's launch vehicle.

Embodiments of the present invention provides an approach for launching satellites in proper path to participate in edge-computing. One approach involves classifying the 3D space based on availability of edge computing resources (based on various orbital position around the earth), and identifying the classified 3D space, where the edge computing resource capability has either been reduced, damaged, or required.

Another approach in another embodiment, involves identifying the satellites that are, i) present on different relative orbital position around the earth, ii) expected remaining life of the satellites and iii) have edge computing capabilities (e.g., storage and processing memory etc.).

Other embodiments of the present invention may recognize one or more of the following facts, potential problems, potential scenarios, and/or potential areas for improvement with respect to the current state of the art: i) identifying current health of satellites that are present in orbits and ii) identifying orbits, trajectories, and paths to launch new satellites to participate in an edge-computing ecosystem.

### DEFINITIONS

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

Orbits of satellites can include LEO (low earth orbit) and/or GEO (geostationary) positions around the earth.

### DESCRIPTION OF FIGURES

It should be understood that the Figures are merely schematic and are not drawn to scale. It should also be understood that the same reference numerals are used throughout the Figures to indicate the same or similar parts.

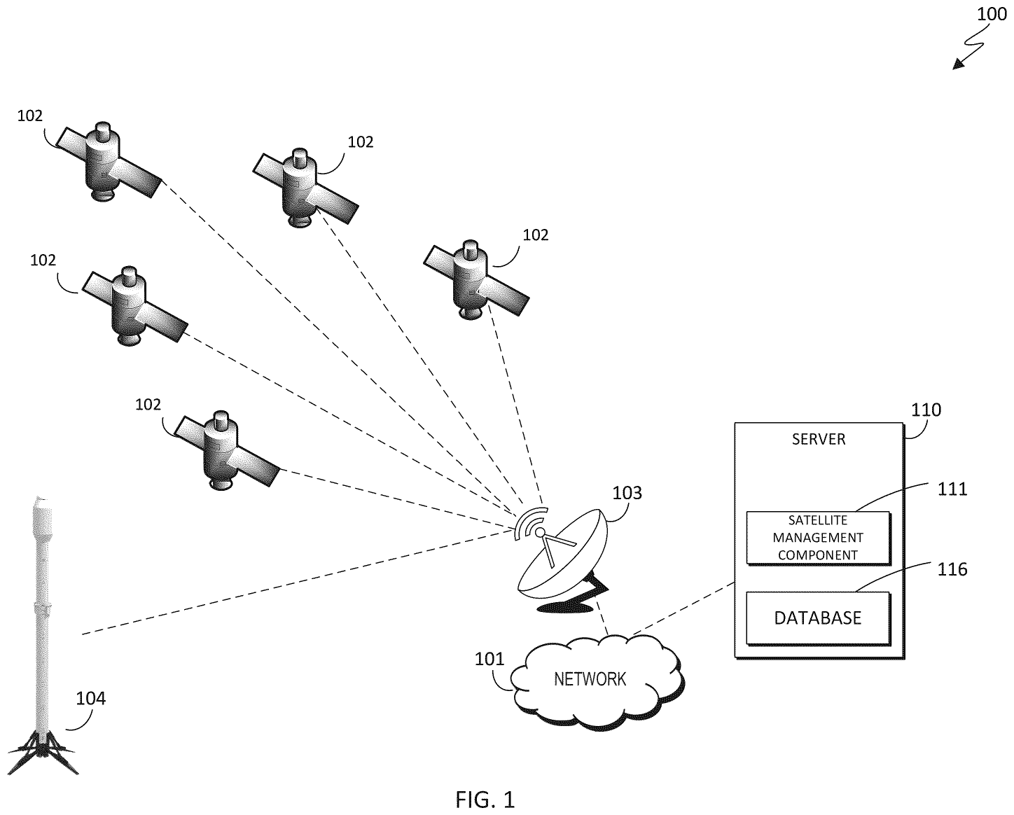

FIG. 1 is a diagram illustrating a high level overview of the functionality of the system, designated as environment 100, in accordance with an embodiment of the present invention;

Environment 100 includes network 101, satellites 102, satellite communication station 103, satellite launch vehicle (SLV) 104 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, satellite communication station 103 and other computing devices (not shown) within environment 100. It is noted that other computing devices can include, but is not limited to, sensors 103 and any electromechanical devices capable of carrying out a series of computing instructions.

Satellites 102 are artificial objects placed in orbit around a planet or stars. Typically, the satellites have various functionality and capabilities, such as, communication relay, weather forecasting, navigation (GPS), broadcasting, scientific research, and Earth observation. Never the less, the satellites contain computerized electronic equipment that are capable of communication (e.g., transmitting and/or receiving data) to other satellites or ground base communication equipment (i.e., satellite communication station 103). Furthermore, one or more satellites (i.e., in certain orbits and forming a group) can provide edge computing amongst themselves and/or to earth based communication stations (i.e., 103).

Satellite communication station 103 are ground/earth based stations capable of communicating to satellites in orbit and/or to other ground stations. Satellite communication stations 103 can rely on radio frequency or laser based to achieve communication between the earth and space.

Satellite launch vehicle (SLV) 104 are vehicles designed to carry satellites into orbit from the ground. SLV 104 can be a rocket or could be a modified airplane capable of launching satellites from the ground into space.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any other programmable electronic device capable of communicating with other computing devices (not shown) within environment 100 via network 101. In another embodiment, server 110 represents a computing system utilizing clustered computers and components (e.g., database server computers, application server computers, etc.) that act as a single pool of seamless resources when accessed within environment 100.

Embodiment of the present invention can reside on server 110 or in a cloud computing environment. Server 110 includes satellite management component 111 and database 116.

Satellite management component 111 provides the following capability, but it is not limited to, i) identifying the satellites that are, a) present on different relative orbital position around the earth, b) expected remaining life of the satellites and c) have edge computing capabilities (e.g., storage and processing memory etc.); and ii) classifying the 3D space based on availability of edge computing resources (based on various orbital position around the earth, and iii) identifying the classified 3D space, where the edge computing resource capability has either been reduced, damaged or required.

Satellite management component 111 can perform the above functionality through a machine learning process and/or as preprogrammed algorithms. Embodiment is agnostic to what type of machine learning process to use and can be determined based on the need of the user.

The following paragraphs attempt to explain on how satellite management component 111 is able to perform the recited functionality:

### Distance Calculation

Each and every satellite already has a specific amount of computing resource, like processing and storage memory. The satellites are in constant communicate with each other, while the performing edge computation. One way where edge computing between satellites can be achieved is based on distance between each satellite. The satellites within the proximity (lowest possible distance ranges) of each other can perform edge computation. Thus, each and every satellite will contribute to computing resources and combine (computing power) in order to create aggregated edge resources. For example, x1, x2, x3 and x4 denote computing resources with individual satellites with the proximity distance ranges. So, the aggregated edge resources will be equal to X which is the sum of all individual resources (e.g., sum of x1, x2, x3 and x4). Depending on what edge computation application is required, for example, weather monitoring or fire prediction may require a certain amount of data and/or CPU processing time to complete the computation.

In other embodiments, satellite management component 111 can utilize the least mean square method to identify the effective trajectory of the launch vehicle and ground location from where to launch the new satellite.

Database 116 is a repository for data used by satellite management component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within environment 100, provided that satellite management component 111 has access to database 116. Database 116 may store information associated with, but is not limited to, knowledge corpus, edge computing resources, satellite computing hardware, available orbital positions around the earth, satellite launch vehicle, ability to calculate launch trajectory and place satellite(s) in desired orbit, satellite communication systems, database for space weather forecast, database for earth weather forecast, database of known public satellites in orbit that are either active or inactive, laser based communication and radio frequency based communication.

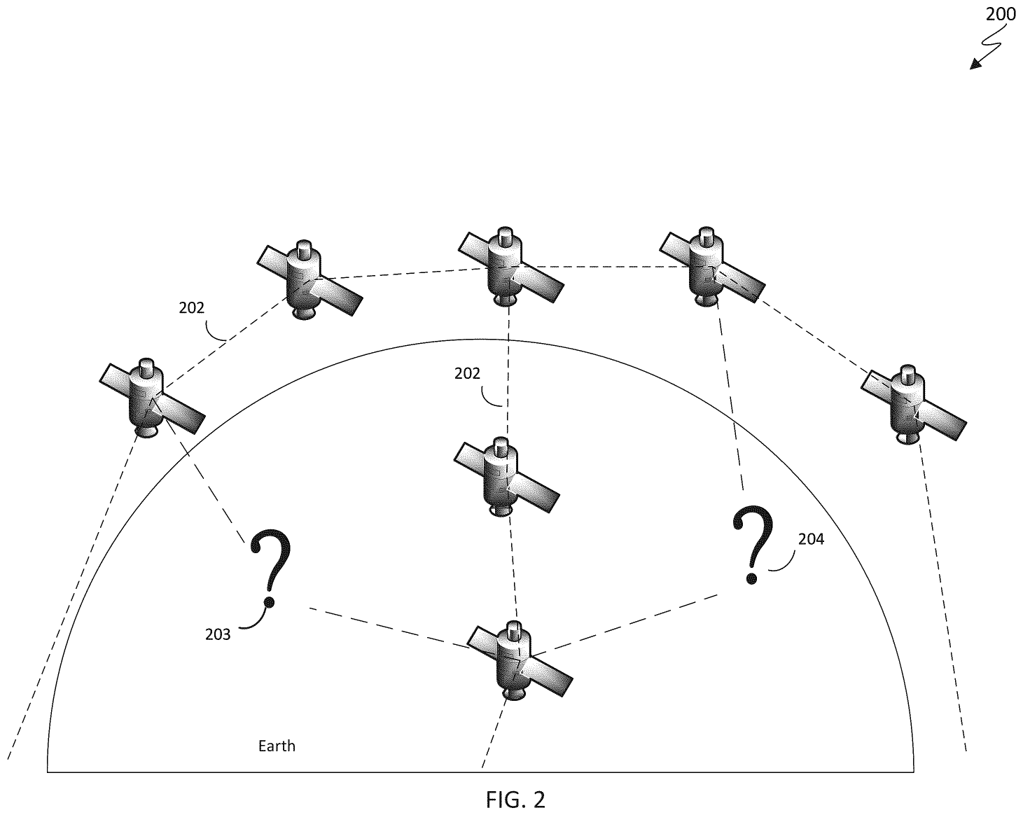

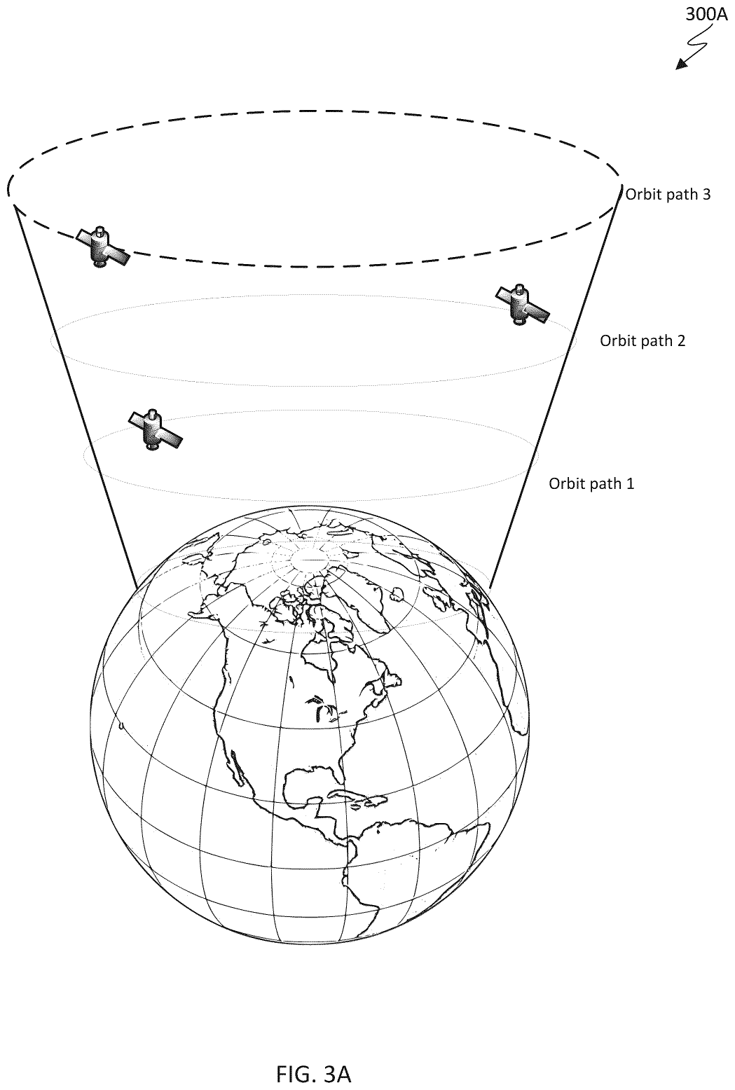

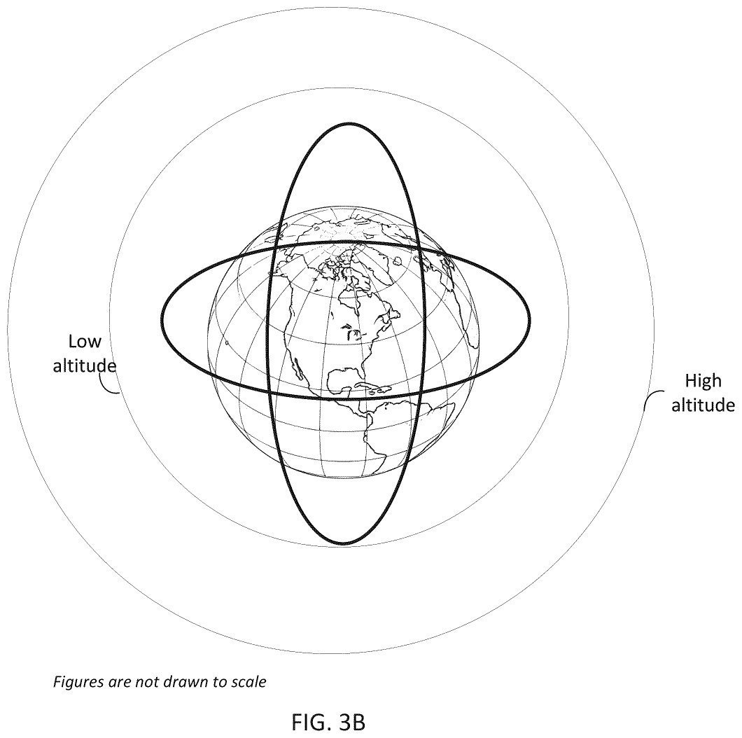

FIG. 2 is a diagram illustrating satellite positioning and possible gaps in edge computing infrastructure, designated as 200, in accordance with an embodiment of the present invention. Orbit path 202 illustrates the current path and/or network links between cluster of satellites, wherein edge computing is fully operational and functional. As previously mentioned regarding the capability of satellite management component 111, wherein embodiment can identify gaps in edge computing infrastructure within a cluster of satellites (in existing orbits). FIG. 3 adds upon the concept of FIG. 2 to other orbital layers surrounding in the earth (i.e., in 3D space).

Each and every satellite already has a specific amount of computing resource, like processing and storage memory. The satellites are in constant communicate with each other. while the performing edge computation. One way where edge computing between satellites can be achieved is based on distance between each satellite. The satellites within the proximity (lowest possible distance ranges) of each other can perform edge computation. Thus, each and every satellite will contribute to computing resources and combine (computing power) in order to create aggregated edge resources. For example, x1, x2, x3 and x4 denote computing resources with individual satellites with the proximity distance ranges (i.e., via the current orbit path 202). So, the aggregated edge resources will be equal to X which is the sum of all individual resources (e.g., sum of x1, x2, x3 and x4 ). Depending on what edge computation application is required, for example, weather monitoring or fire prediction may require a certain amount of data and/or CPU processing time to complete the computation.

This requirement of resource and/or time will be designated as Y for the cluster of satellites to complete the calculation. Satellite management component 111 can determine if there are enough resources for the computation by comparing X against Y. In one example, if X>Y, then no additional edge resource is required. However, if X<Y then there is a need for additional computing resource. Satellite management component 111 will determine the required edge resources based on region range, and then 111 can identify the orbital range shortage of edge resources and can identify where the edge resources will be required (i.e., location of satellites to be placed).

As a result, satellite management component 111 can direct SLV 104 to deploy new satellites in the gap location (e.g., position 203 and position 204 of FIG. 2) and/or possibly direct existing satellites to maneuver into new positions to “fill” in the gap of edge computing.

In other embodiments, satellite management component 111 can utilize least mean square method to identify the effective trajectory of the launch vehicle and ground location from where to launch the new satellite.

FIG. 3A is a diagram illustrating orbital zones in a 3D space relative to the earth as it relates to edge computing infrastructure, designated as 300A, in accordance with an embodiment of the present invention. FIG. 2 discussed a certain orbital zone for edge computing for one particular orbit. However, the space surrounding the earth can be classified as orbital layers, such as orbit path 1, orbit path 2 and orbit path 3 (see FIG. 3A). Thus, satellite management component 111 can identify other gaps associated with edge computing deficiencies in other orbital layers.

FIG. 3B is a diagram illustrating a different perspective/view relating to orbital zones from FIG. 3A, in accordance with an embodiment of the present invention.

Generally, satellites can occupy different positions (altitude away from the earth) and various paths across the earth, where the position and altitude is depending on the scope of the functionality of the satellite (e.g., weather satellites overlooking the U.S. may be in fixed position over the US instead of orbiting around a specific path, etc.). In terms of altitude, the lower altitude for a satellite may provide unobstructed view of the earth, while at higher altitude, it is more difficult. However, at higher altitude, the solar panels of the satellite may be fully deployed to capture the ray from the sun to power its batteries. Again, depending on the use, satellites may occupy different height/altitude to either take advantage of the ray from the sun or chose to be closer to the earth.

In another embodiment, as it relates to FIG. 3B, instead of a system of space satellites, it is possible to leverage one or more high altitude UAVs (unmanned aerial vehicle) to perform the same functionality associated with an edge-computing infrastructure. The high altitude UAV can contain solar panels that may allow it to orbit/fly without having to recharge or land to recharge. Thus, a network/cluster of high altitude UAVs may be leveraged instead of a cluster of space satellites. Furthermore, it may be advantageous and quick to launch UAVs to cover any gaps and/or deficiency in edge computing infrastructure.

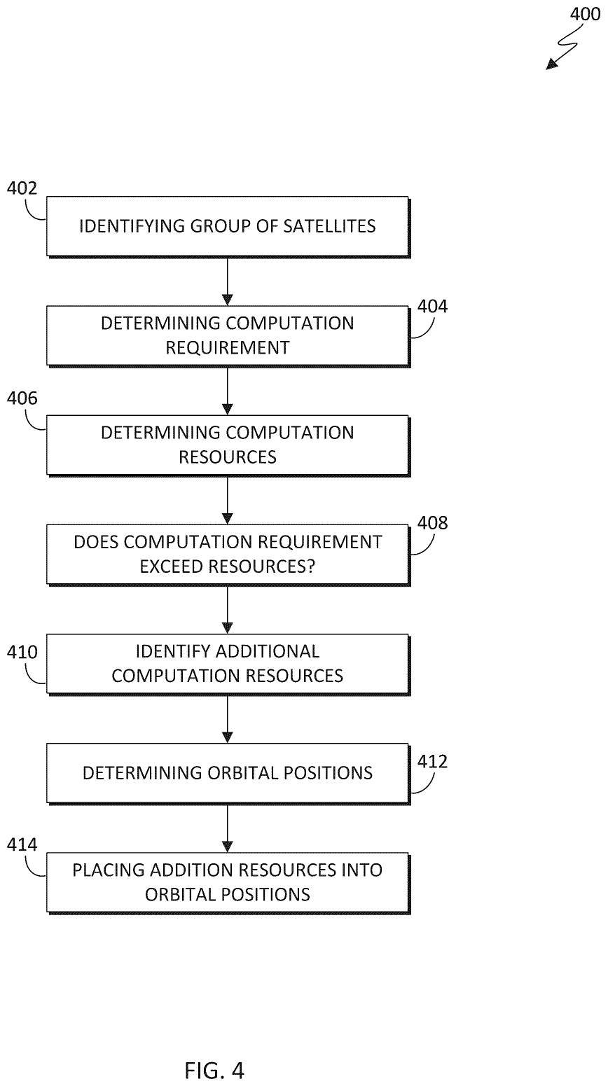

FIG. 4 is a high-level flowchart illustrating the operation of satellite management component 111, designated as 400, in accordance with an embodiment of the present invention.

Satellite management component 111 identifies a group of satellites using edge computing (step 402). In an embodiment, satellite management component 111, identifies a group of satellites that are using edge computing. Recall that each and every satellite already has a specific amount of computing resource, like processing and storage memory. The satellites are in constant communicate with each other, while performing edge computation. Thus, satellite management component 111 can easily and readily identify a group of satellites utilizing edge computing and/or is part of the edge-computing infrastructure.

Satellite management component 111 determines a computation requirement associated with the edge computing (step 404). Depending on what edge computation application is required, the computational requirement can be designated as Y. For example, weather monitoring or fire prediction may require a certain amount of data and/or CPU processing time to complete by the cluster of satellites, this data and time can be designated as Y.

In another embodiment, each application actively computing can be designated as Y1 and subsequent applications as Y2 . . . Yn, where n denotes the total number of active applications. Thus, the summation of Y1 all the way to Yn can be designated as Y.

Satellite management component 111 determines existing computational resources associated by the group of satellites (step 406). In an embodiment, each satellite has a set of computing hardware with resource limitations (e.g., maximum memory and processing unit). However, as a group, a cluster of satellites can increase its processing power and reduce calculation time. For example, x1, x2, x3 and x4 denote computing resources with individual satellites with the proximity distance ranges. Thus, the aggregated edge resources will be equal to X which is the sum of all individual resources (e.g., sum of x1, x2, x3 and x4 ).

Satellite management component 111 determines whether the computation requirement exceeds the existing computation resources (step 408). In an embodiment, satellite management component 111, can determine if there are enough resources for the computation by comparing X against Y. In one example, if X>Y, then no additional edge resource is required.

Having determined that the computational requirement does exceed the existing computation resources (X<Y), satellite management component 111 identifies addition resources required (step 410). Satellite management component 111 will determine the required edge resources (i.e., more satellites) based on the region range. Furthermore, satellite management component 111 can identify what kind of satellite with a specific hardware (i.e., computational capability) that can satisfy the current computational requirement (i.e., Y). For example, satellite management component 111 has determined that there is a need for additional computing resource and has selected two weather satellites (e.g., Meteosat Third Generation and GOES-R) with a certain hardware capability that (once combined with existing satellites utilizing edge computing) can meet the computation requirement (i.e., Y).

Satellite management component 111 determines one or more orbital positions for the additional resources (step 412). In an embodiment, satellite management component 111, has already determined how many satellites will be required to overcome the deficient computing resources. Satellite management component 111 can identify the orbital range shortage of edge resources and can identify where the edge resources will be required (i.e., location of satellites to be placed). For example, (refer to FIG. 2) satellite management component 111 has identified orbital positions of 203 and 204 where new satellites should be placed.

Satellite management component 111 places the additional resources into the one or more orbital positions in order to participate in the edge computing (step 414). In an embodiment, satellite management component 111 can command/instruct SLV 104 to deliver and position two additional satellites into orbit, towards position 203 and position 204 (of FIG. 2).

### Other Embodiments/Comments

Other embodiments of the present invention may include the following method, steps and/or systems: a high altitude UAV (unmanned aerial vehicle) performing the same functionality and capability of the satellites associated with an edge-computing infrastructure. The UAV can contain solar panels that may allow it to orbit/fly without having to recharge or land to recharge. Thus, a network/cluster of high altitude UAV may be leveraged instead of a cluster of space satellites. Furthermore, it may be advantageous and quick to launch UAVs to cover any gaps and/or deficiency in edge computing infrastructure.

Other embodiments of the present invention may include the following method, steps and/or systems: i) a method for dynamic trajectory path of satellite launching vehicle determination to ensure launching of satellite in the space which can participate in edge-computing; and ii) a step wherein around different orbital position around the earth, classifying the 3D space based on availability of edge-computing resources and will be identifying the classified 3D space where the edge-computing resource capability has reduced, damaged and required.

Other embodiments of the present invention may include the following method, steps and/or systems: i) a step wherein based on identified condition of the satellites with expected remaining life of the satellites, and edge-computing capabilities (storage and processing memory) etc.; and ii) identifying the relative areas around the earth orbits where edge-computing capability has reduced or going to reduce and accordingly the launching vehicle will identifying appropriate trajectory so that, satellites can be launched from the launching vehicle in appropriate place of the orbit to ensure required edge-computing capability is available in different classified 3D space.

Other embodiments of the present invention may include the following method, steps and/or systems: a step wherein considering the identified 3D space location in different orbital positions where LEO satellites are to be placed to ensure required edge-computing capacity, the system will be using least square method to identify the optimum trajectory of launching vehicle so that the launching of satellites can be performed effectively.

Other embodiments of the present invention may include the following method, steps and/or systems: a step of analyzing the edge-computing need with required edge-computing capabilities in the space, and accordingly identifying how the satellites are to be placed on the orbits so that required level of satellite edge-computing on the space can be ensured, and accordingly the launching vehicle will identify appropriate trajectory path.

Other embodiments of the present invention may include the following method, steps and/or systems: a step of estimating where the satellites are to be placed in different orbits, and accordingly identifying optimum trajectory path of the satellites, and at what orbital position the satellite is to be launched so that the launching vehicles can effectively place the satellites on the orbits.

Other embodiments of the present invention may include the following method, steps and/or systems: a step wherein while the satellites are be launched, then it will have kinetic inertia because of the kinetic motion of the launching vehicle, and accordingly the launching vehicle will identify when to release the satellite, so that satellites can be placed on the orbit for required edge-computing capabilities.

Alternatively, the proposed concept/steps/methods and systems may be summarized in a nutshell in the following clauses:
1. Each and every satellite on the orbit can be identified uniquely and will also be identifying the specifications of the satellites.
2. The proposed system will also be identifying the expected life and remaining life of the satellites.
3. The proposed system identifying the health of each and every satellite on the orbit and will also be identifying the edge-computing capabilities (like storage and processing memory).
4. The proposed system can be identifying the relative positions of different satellite with respect to earth position, and with respect to different orbital satellites.
5. Based on the edge-computing capabilities of different satellites, relative positions of the satellites, the proposed system can be identifying the area on the orbit with edge-computing capabilities.
6. Based on the data captured from the satellites, the proposed system can be classifying different orbital areas based on edge-computing capabilities.
7. The proposed system can be identifying how long the satellites can provide required edge-computing capabilities.
8. In this case the proposed system can be considering the remaining lifespan of the satellites and when the satellites are to be replaced.
9. The proposed system can be identifying the orbital areas where the edge-computing capability is less or can be getting reduced.
10. The proposed system can be identifying the orbital movement of the satellites and can be identifying the position of the satellites in different timing.
11. The proposed system can be identifying where the satellites are to be placed to ensure the required edge-computing capabilities.
12. The proposed system can be identifying required number of satellites are to be placed in different orbital position.
13. The launching vehicle can be carrying required number of satellites and can be taking off for deploying satellites.
14. The launching vehicle can be communicating with ground station to identify the satellite positions on the orbit and where the satellites are to be placed.
15. The satellite launching vehicle can be identifying the relative positions of the satellite and can be identifying where the satellites are to be deployed to that required edge-computing capability can be ensured.
16. The launching vehicle can be identifying appropriate trajectory so that the satellites can be deployed in correct places.
17. The satellite launching vehicle can be estimating the kinetic inertia on the satellite if the any satellite is released and if can reach at the required destination.
18. The launching vehicle can be identifying appropriate trajectory path and gradually be deploying the satellites.
19. The launching vehicles can be identifying the places where the satellites are to be deployed, and accordingly be identifying the optimum travel path.
20. While the launching vehicles are travelling, then it will continue to deploy satellite along with its trajectory path.

### Hardware Environment

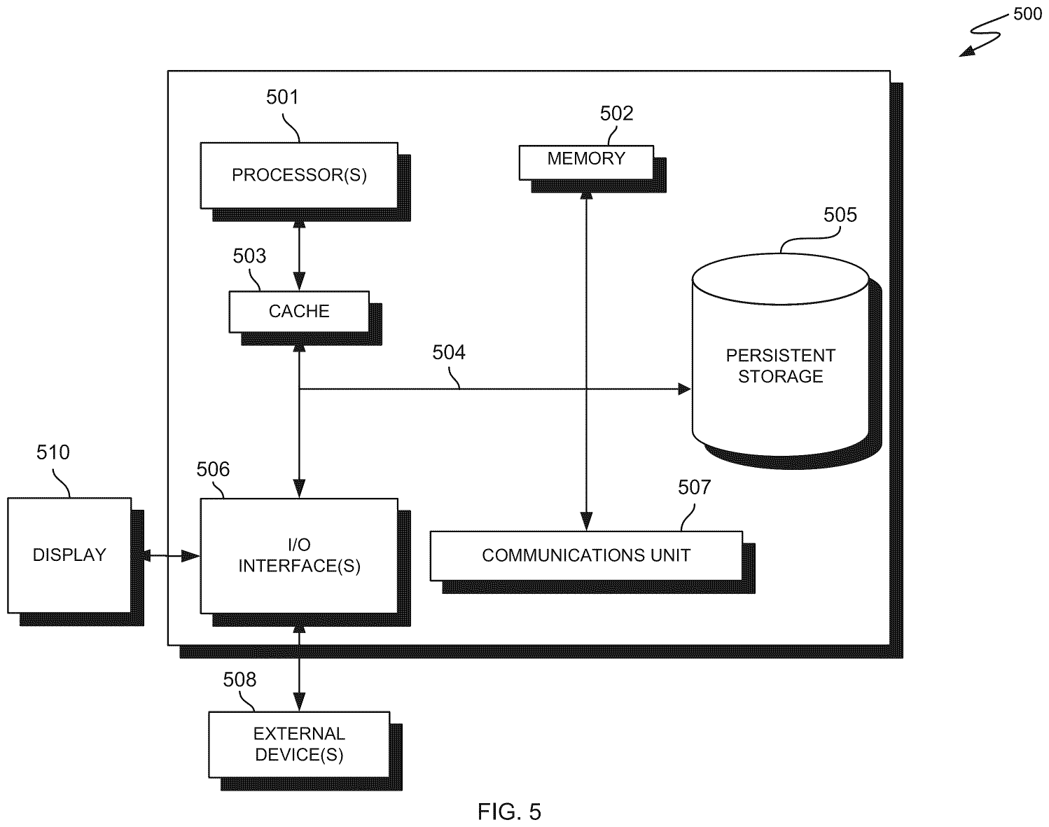

FIG. 5, designated as 500, depicts a block diagram of components of satellite management component 111 application, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

It is to be understood that embodiments of the present invention may be executed inside a cloud-computing infrastructure and is not limited to network servers.

FIG. 5 includes processor(s) 501, cache 503, memory 502, persistent storage 505, communications unit 507, input/output (I/O) interface(s) 506, and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processor(s) 501 by holding recently accessed data, and data near recently accessed data, from memory 502.

Program instructions and data (e.g., software and data x10) used to practice embodiments of the present invention may be stored in persistent storage 505 and in memory 502 for execution by one or more of the respective processor(s) 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. Satellite management component 111 can be stored in persistent storage 505 for access and/or execution by one or more of the respective processor(s) 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data (e.g., Satellite management component 111) used to practice embodiments of the present invention may be downloaded to persistent storage 505 through communications unit 507.

I/O interface(s) 506 allows for input and output of data with other devices that may be connected to each computer system. For example, I/O interface(s) 506 may provide a connection to external device(s) 508, such as a keyboard, a keypad, a touch screen, and/or some other suitable input device. External device(s) 508 can also include portable computer readable storage media, such as, for example, thumb drives, portable optical or magnetic disks, and memory cards. Program instructions and data (e.g., Satellite management component 111) used to practice embodiments of the present invention can be stored on such portable computer readable storage media and can be loaded onto persistent storage 505 via I/O interface(s) 506. I/O interface(s) 506 also connects to display 510.

Display 510 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for managing location of satellites associated with edge computing, the computer-implemented method comprising:
identifying a group of satellites using the edge computing;
determining a computation requirement associated with the edge computing;
determining existing computational resources associated the group of satellites;
determining whether the computation requirement exceeds the existing computation resources;
in responsive to having determined that the computational requirement does exceed the existing computation resources, identifying addition resources required;
determining one or more orbital positions for the additional resources; and
placing the additional resources into the one or more orbital positions in order to participate in the edge computing.

2. The computer-implemented method of claim 1, wherein determining the computation requirement further comprising:
identifying software applications currently active with the identified group of satellites; and
determining the computational requirement, wherein the computational requirement comprises of, an input data, duration and/or CPU (central processing unit) processing time required with the identified software applications and designating the computational requirement as a variable, Y.

3. The computer-implemented method of claim 1, wherein determining the existing computational resources further comprising:
determining computing hardware for each satellite belonging to the group of satellites;
designating each of the computer hardware for each satellite as X1 all the way to Xn, where n denotes total number of satellites from the group of satellites; and
summing up X1 to Xn and designating combined summation as variable X.

4. The computer-implemented method of claim 1, wherein determining whether the computation requirement exceeds the existing computation resources further comprises:
comparing whether the variable X is greater than or less than the variable Y.

5. The computer-implemented method of claim 1, wherein identifying additional resources required further comprising:
determining whether other satellites in a different orbit can be utilized;
having determined that the other satellites in the different orbit cannot be utilized, identifying a gap of missing resources that can satisfy the computational requirement; and
selecting new satellites based on its hardware capability that meets the gap of missing resources.

6. The computer-implemented method of claim 5, wherein the one or more orbital positions further comprises:
calculating one or more target orbits that can satisfy the gap of missing resources; and
matching the new satellites to be utilized with the or more target orbits.

7. The computer-implemented method of claim 6, wherein placing the additional resources further comprising:
directing launch vehicle to deliver the new satellites towards the one or more target orbits.

8. A computer program product for managing location of satellites associated with edge computing the computer program product comprising:
one or more computer-readable storage media having computer-readable program instructions stored on the one or more computer-readable storage media said program instructions executes a computer-implemented method comprising the steps of:
identifying a group of satellites using the edge computing;
identifying a group of satellites using edge computing;
determining a computation requirement associated with the edge computing;
determining existing computational resources associated the group of satellites;
determining whether the computation requirement exceeds the existing computation resources;
in responsive to having determined that the computational requirement does exceed the existing computation resources, identifying addition resources required;
determining one or more orbital positions for the additional resources; and
placing the additional resources into the one or more orbital positions in order to participate in the edge computing.

9. The computer program product of claim 8, wherein determining the computation requirement further comprising:
identifying software applications currently active with the identified group of satellites; and
determining the computational requirement, wherein the computational requirement comprises of, an input data, duration and/or CPU (central processing unit) processing time required with the identified software applications and designating the computational requirement as a variable, Y.

10. The computer program product of claim 8, wherein determining the existing computational resources further comprising:
determining computing hardware for each satellite belonging to the group of satellites;
designating each of the computer hardware for each satellite as X1 all the way to Xn, where n denotes total number of satellites from the group of satellites; and
summing up X1 to Xn and designating combined summation as variable X.

11. The computer program product of claim 8, wherein determining whether the computation requirement exceeds the existing computation resources further comprises:
comparing whether the variable X is greater than or less than the variable Y.

12. The computer program product of claim 8, wherein identifying additional resources required further comprising:
determining whether other satellites in a different orbit can be utilized;
having determined that the other satellites in the different orbit cannot be utilized, identifying a gap of missing resources that can satisfy the computational requirement; and
selecting new satellites based on its hardware capability that meets the gap of missing resources.

13. The computer program product of claim 12, wherein the one or more orbital positions further comprises:
calculating one or more target orbits that can satisfy the gap of missing resources; and
matching the new satellites to be utilized with the or more target orbits.

14. The computer program product of claim 13, wherein placing the additional resources further comprising:
directing launch vehicle to deliver the new satellites towards the one or more target orbits.

15. A computer system for managing location of satellites associated with edge computing, the computer system comprising:
one or more computer processors; and
one or more computer readable storage media having computer-readable program instructions stored on the one or more computer readable storage media, said program instructions executes, by the one or more computer processors, a computer-implemented method comprising the steps of:
identifying a group of satellites using the edge computing;
determining a computation requirement associated with the edge computing;
determining existing computational resources associated the group of satellites;
determining whether the computation requirement exceeds the existing computation resources;
in responsive to having determined that the computational requirement does exceed the existing computation resources, identifying addition resources required;
determining one or more orbital positions for the additional resources; and
placing the additional resources into the one or more orbital positions in order to participate in the edge computing.

16. The computer system of claim 15, wherein determining the computation requirement further comprising:
identifying software applications currently active with the identified group of satellites; and
determining the computational requirement, wherein the computational requirement comprises of, an input data, duration and/or CPU (central processing unit) processing time required with the identified software applications and designating the computational requirement as a variable, Y.

17. The computer system of claim 15, wherein determining the existing computational resources further comprising:
determining computing hardware for each satellite belonging to the group of satellites;
designating each of the computer hardware for each satellite as X1 all the way to Xn, where n denotes total number of satellites from the group of satellites; and
summing up X1 to Xn and designating combined summation as variable X.

18. The computer system of claim 15, wherein determining whether the computation requirement exceeds the existing computation resources further comprises:
comparing whether the variable X is greater than or less than the variable Y.

19. The computer system of claim 15, wherein identifying additional resources required further comprising:
determining whether other satellites in a different orbit can be utilized;
having determined that the other satellites in the different orbit cannot be utilized, identifying a gap of missing resources that can satisfy the computational requirement; and
selecting new satellites based on its hardware capability that meets the gap of missing resources.

20. The computer system of claim 15, wherein the one or more orbital positions further comprises:
calculating one or more target orbits that can satisfy the gap of missing resources; and
matching the new satellites to be utilized with the or more target orbits.
